(19) United States
(12) Patent Application Publication
(10) Pub. No.: US 2008/0050016 A1
(43) Pub. Date: Feb. 28, 2008

(54) Image processing apparatus, image processing method, computer readable medium, and computer data signal

(75) Inventors: Hiroyuki Kawano, Kanagawa (JP); Yuzuru Suzuki, Kanagawa (JP); Atsushi Itoh, Kanagawa (JP); Kunikazu Ueno, Kanagawa (JP); Koichi Fujii, Kanagawa (JP); Natsumi Miyazawa, Kanagawa (JP); Shunsuke Kodaira, Kanagawa (JP)

Correspondence Address: OLIFF & BERRIDGE, PLC, P.O. BOX 320850, ALEXANDRIA, VA, 22320-4850, US

(73) Assignee: FUJI XEROX CO., LTD., TOKYO (JP)

(21) Appl. No.: 11/783,396

(22) Filed: Apr. 9, 2007

(30) Foreign Application Priority Data
Aug. 28, 2006 (JP) 2006-229957

(51) Int. Cl. G06K 9/34

(52) U.S. Cl. 382/175

(57) ABSTRACT

An image processing apparatus includes: an image decomposition unit that decomposes an input image into component images constituting the input image; a confidentiality setting unit that sets a confidentiality being a degree of security of each of the component images into which the input image is decomposed by the image decomposition unit; and a storage unit that stores each of the component images by associating the confidentiality therewith, the confidentiality being set by the confidentiality setting unit.

### CROSS-REFERENCE TO RELATED APPLICATIONS

This application is based on and claims priority under 35 U.S.C. 119 from Japanese Patent Application No. 2006-229957 filed Aug. 28, 2006.

### BACKGROUND

1. Technical Field

The present invention relates to an image processing apparatus, to an image processing method, to a computer readable medium, and to a computer data signal.

2. Related Art

Recently, the management of the security of documents used in business has been demanded from the viewpoint of the protection of information.

In a case where documents needing the security management should be distributed as paper documents, images can easily be copied. Thus, it is difficult to assure the security of the documents.

### SUMMARY

According to an aspect of the present invention, an image processing apparatus includes: an image decomposition unit that decomposes an input image into component images constituting the input image; a confidentiality setting unit that sets a confidentiality being a degree of security of each of the component images into which the input image is decomposed by the image decomposition unit; and a storage unit that stores each of the component images by associating the confidentiality therewith, the confidentiality being set by the confidentiality setting unit.

### BRIEF DESCRIPTION OF THE DRAWINGS

Exemplary embodiment of the present invention will be described in detail based on the following figures, wherein:

FIG. 1 is a diagram illustrating the configuration of conceptual modules according to an exemplary embodiment of the invention;

FIG. 2 is the configuration of the entire exemplary system in the case of implementing this exemplary embodiment of the invention;

FIG. 3 is an explanatory diagram illustrating an example of a process performed by this exemplary embodiment of the invention;

FIG. 4 is a diagram illustrating an example of the structure of data representing a result of performing an image decomposition process;

FIG. 5 is a diagram illustrating an example of the structure of data representing the corresponding relation between security levels and output modes;

FIG. 6 is a flowchart illustrating an example of a process of storing an image, the security level of which is set;

FIG. 7 is a flowchart illustrating a process of changing the output mode; and

FIG. 8 is a block diagram illustrating an example of the configuration of hardware of this exemplary embodiment of the invention.

### DETAILED DESCRIPTION

Hereinafter, a preferred embodiment of the invention is described with reference to the accompanying drawings.

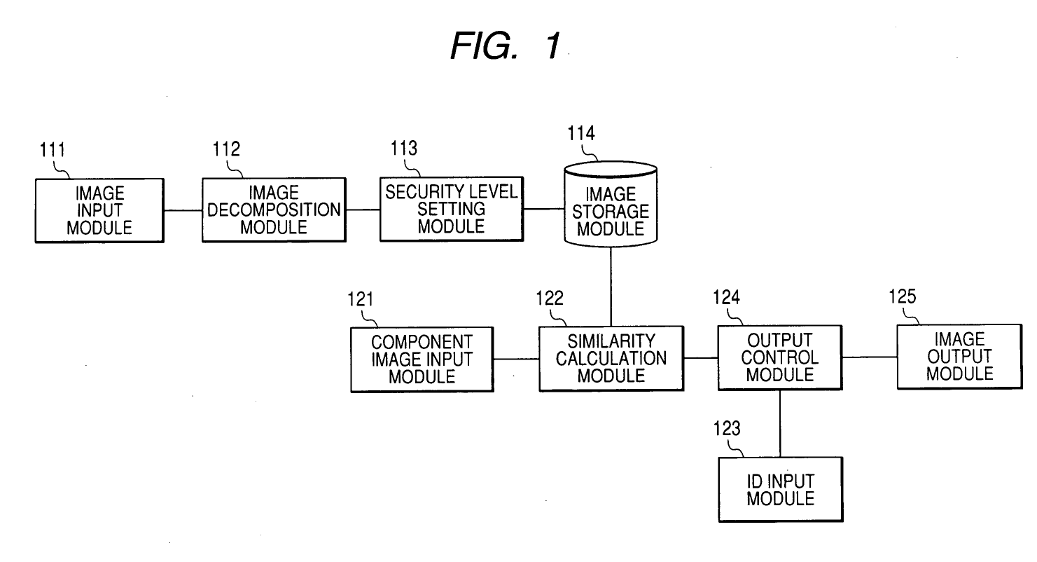

The accompanying drawings illustrate the embodiment of the invention. FIG. 1 is a diagram illustrating the configuration of conceptual modules according to the embodiment of the invention.

Incidentally, the term “module” designates a component of software and hardware, which is generally logically separable therefrom. Thus, the “module” according to the present embodiment designates not only a module of a program but a module of hardware. Thus, the description of the present embodiment also serves as the description of a program, a system, and a method. The modules correspond substantially one-to-one to the functions. When implementing modules, one module may be constituted by one program. Alternatively, a plurality of modules may be constituted by one program. Conversely, one module may be constituted by a plurality of programs. Also, a plurality of modules may be executed by either one computer or a plurality of computers placed in distributed or parallel environment. In the following description, the term “connection” includes not only physical connection but logical connection.

The term “system” includes a system constituted by connecting a plurality of computers or hardware, and apparatuses through a network, and also includes a system implemented by one computer, single hardware, or one apparatus.

In the following description, a security level is employed as a confidentiality by way of example.

As shown in FIG. 1, the present embodiment includes an image input module 111, an image decomposition module 112, a security level (or confidentiality) setting module 113, an image storage module 114, a component image input module 121, a similarity calculation module 122, an ID input module 123, an output control module 124, and an image output module 125.

As shown in FIG. 1, the image input module 111 is connected to the image decomposition module 112. The image input module 111, to which an image is input, sends the input image to the image decomposition module 112. More specifically, the image input module 111 receives an image from a scanner and a camera as electronic information. Images may be input from another system by a facsimile to the image input module 111 through a communication circuit. Alternatively, images may be from a hard disk storing a database, which includes images, to the image input module 111. Incidentally, an image to be input thereto may be constituted by either a single page of image data or a plurality of pages of image data.

As shown in FIG. 1, the image decomposition module 112 is connected to the image input module 111 and to the security level setting module 113. The image decomposition module 112 decomposes an image input by the image input module 111 into component images constituting the input image. Then, the image decomposition module 112 sends data representing a result of the decomposition to the security level setting module 113.

The decomposition of the input image into the component images is performed by extracting an area (or component image), which is separated with spaces, from the input image. The process of decomposing the input image into the component images is performed by binarizing an image input by the image input module 111 and then dividing the input image at a part at which a white pixel area having a predetermined length (or area) is present. A black pixel area (shaped like, for example, a rectangle) can be extracted by such separation. Then, the features (for example, the area, the longitudinal or lateral size, the shape and the location of a black pixel block) of the black pixel area serving as an image are extracted therefrom. Categories of component images, such as a character area, a graphic area, a table area, and a photographic area, can be discriminated from one another. It is apparent that component images can be extracted by another existing method.

Additionally, a character string serving as text data can be generated from a component image serving as a character area by performing character recognition processing thereon. Also, compression processing may be performed on the graphic area and the photographic area according to the properties of such areas.

As shown in FIG. 1, the security level setting module 113 is connected to the image decomposition module 112, and the image storage module 114. The security level setting module 113 sets a security level serving as the degree of security to the component images into which the input image is decomposed by the image decomposition module 12. Data representing a result of the setting of the security levels is stored in the image storage module 114.

The setting of the security levels is performed thereat as follows. That is, the component images, into which the input image is decomposed by the image decomposition module 112, are presented to an operator (generally, an administrator of the document). A security level is set by an instruction from the operator. The security levels are classified into, for example, a “highest” level, a “high” level, a “middle” level, and a “low” level.

As shown in FIG. 1, the image storage module 114 is connected to the security level setting module 113 and the similarity calculation module 122. The image storage module 114 stores the component images, into which the input image is decomposed by the image decomposition module 112, and the security levels set to the component images by the security level setting module 113. That is, each of the component images is stored, together with a corresponding security level, by being associated with the corresponding security level. Mainly the security level setting module writes data to the image storage module 114. Also, mainly the similarity calculation module 122 reads data from the image storage module 114.

More specifically, in a case where the image storage module 114 is implemented by a program, the program controls the data to be stored in a storage portion such as a hard disk or a memory.

As shown in FIG. 1, the component image input module 121 is connected to the similarity calculation module 122. The component image input module 121 inputs a component image selected by an operation performed by an operator (generally, a person outputs a document). More specifically, in a case where a document is designated by an operation performed by the operator, where the printing of the document is instructed by an operation performed by the operator, and where the document includes the component images, the component image input module 121 sends the input component images to the similarity calculation module 12.

Additionally, the component images, into which the input image is decomposed by the image decomposition module 112, may be input to the component image input module 121. More specifically, an operator copies the document by a copier.

As illustrated in FIG. 1, the similarity calculation module 122 is connected to the image storage module 114, the component image input module 121, and the output control module 124. The similarity calculation module 122 calculates the similarity between the component image, which is input by the component image input module 12, and the component image stored in the image storage module 114. Then, the similarity calculation module 122 sends data representing a result of the calculation to the output control module 124.

That is, the component image input by the component image input module 121 is an object image to be retrieved. To retrieve a component image, which is most similar to the object image, from the image storage module 114, the similarity calculation module 122 calculates the similarity between the two component images. There are various methods of calculating the similarity. For example, one such a method is to perform pattern matching on the two component images, and to then detect the difference therebetween. Another method is to extract features (a color arrangement, and an edge position at which change of a color drastically occurs) of each of the component images and to calculate the distance between the two images in a feature space. In a case where the component images are character areas, and where character recognition processing is performed on the component images, it is advisable to calculate the similarity between character strings serving as text data.

The calculation of the similarity may be performed only on the component images of the same kind. That is, the system can be adapted so that the similarity between the component images of difference kinds is not calculated.

Also, in a case where the component images differ in size form each other, the system can be adapted so that the similarity between the component images of difference sizes is not calculated. Conversely, in the case the component images differ in size form each other, the system can be adapted so that one of the components images is increased or decreased in size to have the same size as the size of the other component image, and that the similarity between these two components images is calculated.

The calculation of the similarity includes checking whether the two component images are the same images.

As shown in FIG. 1, the ID input module 123 is connected to the output control module 124. An identifier (ID) of a person trying to print the component image input by the component image input module 121 is input to the ID input module 123. For example, a card reader adapted to read an ID card, or a read configured to read a fingerprint corresponds to the ID input module 123.

As shown in FIG. 1, the output control module 124 is connected to the similarity calculation module 122, the ID input module 123, and the image output module 125. That is, the output control module 124 controls an output mode, in which the component image input by the component image input module 121 is output by the image output module 125, according to the ID of the operator, which is input to the ID input module 123, to the similarity calculated by the similarity calculation module 122, and to the security levels of the component images stored in the image storage module 114. The control of the output mode includes controlling whether the image is output.

However, the output control module 124 is adapted not to control the output mode according to the similarity calculated by the similarity calculation module 122, and to the security levels of the component images stored in the image storage module 114.

The output mode can be controlled to stepwise change the output mode (relating to shapes, patterns, colors, sizes, and resolutions to be employed to output the component image, and in a case where a device, to which the component image is output, is a display device, a manner of blinking) from a mode, in which the component image is output without being changed, to a mode in which the component image is not output at all.

More specifically, in a case where the security level is low, the component image is output without being changed. In a case where the security level is middle, the component image is output by adding a watermark thereto. In a case where the security level is high, an alternative image (for example, a message indicating that the security level is high (for instance, the message “copying is forbidden”) for the component image is output. In a case where the security level is highest, the component image is not output. Additionally, the system keeps it secret whether the component image is present.

As shown in FIG. 1, the image output module 125 is connected to the output control module 124. That is, the image output module 125 outputs the component image according to the control of the output by the output control module 124.

For example, a device, to which the component image is output, is, for example, a printer, or a display. In a case where the component image is output as an electronic document, the device, to which the component image is output, is a storage medium, such as a hard disk.

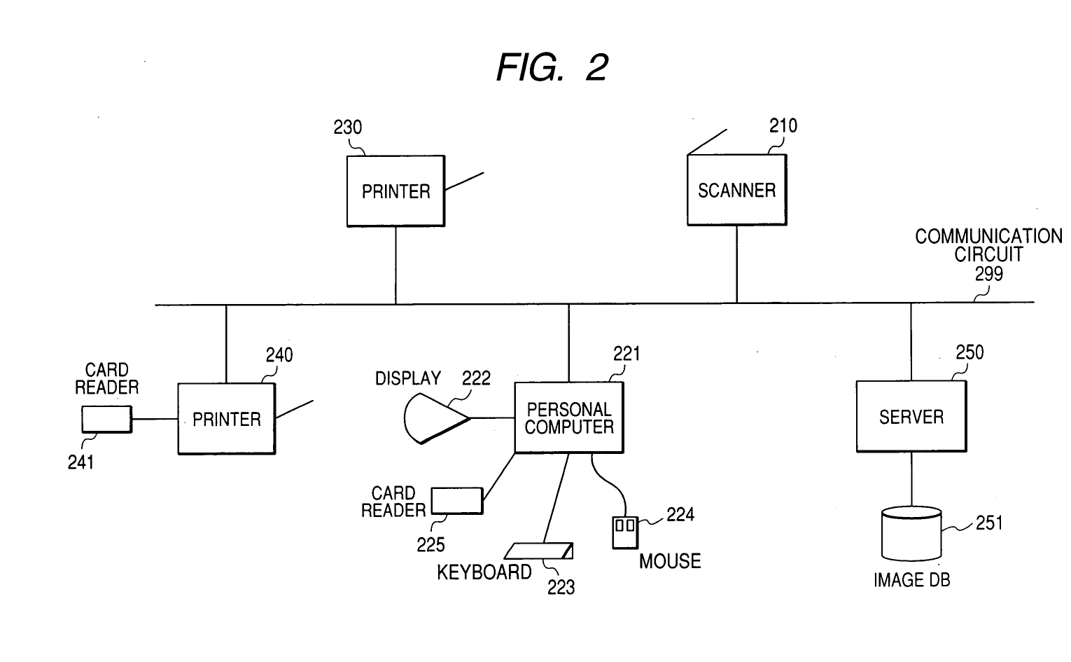

Next, the entire system in the case of implementing the present embodiment is described by referring to FIG. 2.

The system illustrated in FIG. 2 is configured so that a scanner 210, a personal computer 221, a printer 230, a printer 240, and a server 250 are connected to one another through a communication circuit 299.

The scanner 210 corresponds to the image input module 111.

The printers 230 and 240 correspond to the image output module 125.

The server 250 and an image DB 251 correspond to the image storage module 114.

The personal computer 221 decomposes an image input by the scanner 210 into component images, and sets security levels to the component images, and causes the image DB 251 of the server 250 to store a result of setting the security levels. Also, the personal computer 221 outputs to the printer 230 an instruction of outputting a document including other component images therefrom. At that time, the personal computer 221 causes a display device 222 to indicate an image. The instruction is input using the keyboard 223 or the mouse 224. To discriminate the ID of an operator, an ID card is read by a card reader 225. That is, the personal computer 221 includes the image decomposition module 112, the security level setting module 113, the component image input module 121, the similarity calculation module 122, and the output control module 124. The card reader 225 corresponds to the ID input module 123.

Additionally, all or a part of the image decomposition module 112, the security level setting module 113, the component image input module 121, the similarity calculation module 122, and the output control module 124 may be implemented by the scanner 210, the server 250, and the printer 240 other than the personal computer 221. For example, the printer 240 may have the card reader 241 and also may implement the similarity calculation module 122 and the output control module 124 when the printer 240 prints an image.

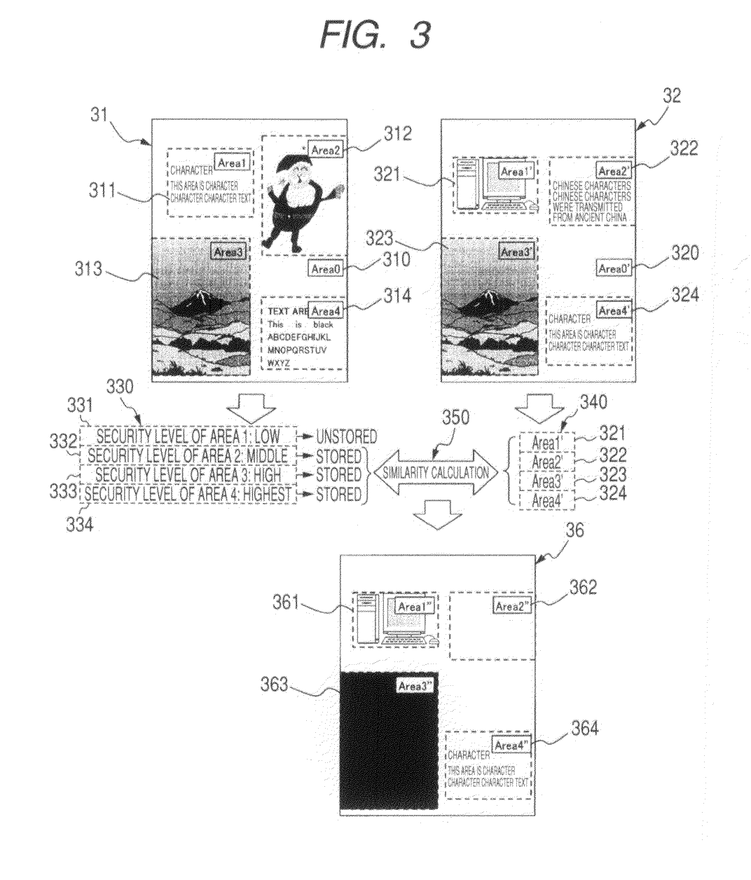

Next, an example of processing performed by the present embodiment is described by referring to FIG. 3.

An image 31 indicated at an upper left part of FIG. 3 is input by the image input module 111.

As a result of processing performed by the image decomposition module 112, the image 31 is decomposed into areas Area0 (310), Area1 (311), Area2 (312), Area3 (313), Area4 (314). Then, the security levels are set to component images by the security level setting module 113, respectively. The area Area0 (310) is a background image and is not a component image to be processed.

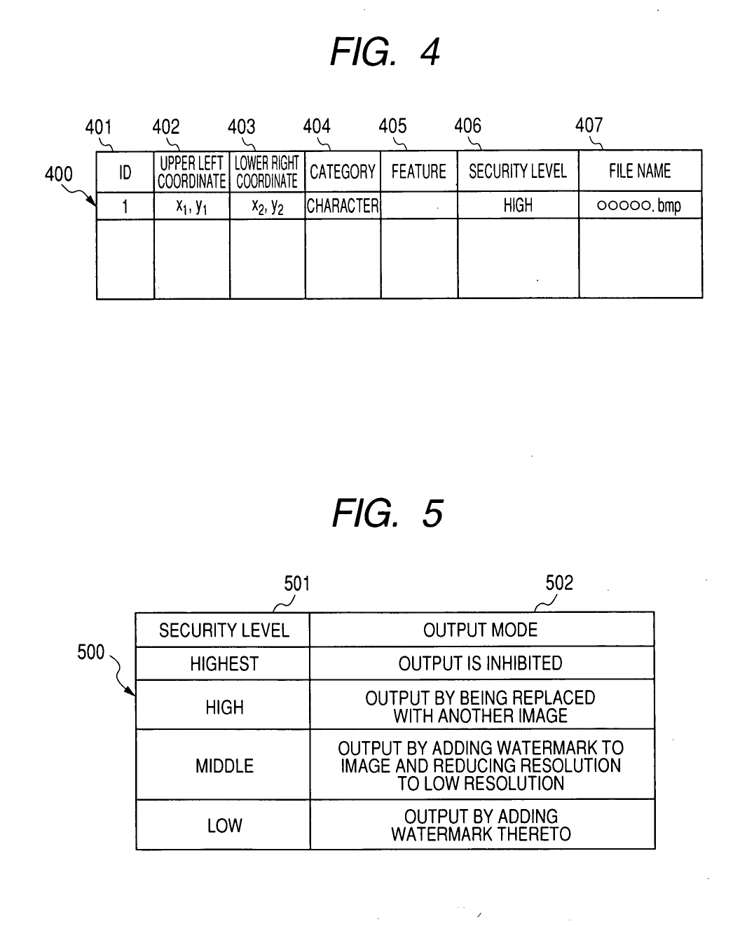

A result of processing performed by the image decomposition module 112, and the security level setting module 113 is stored in a component image table 400 having a data structure illustrated in FIG. 4. That is, the component image table 400 has an ID column 401, an upper left coordinate column 402, a lower right coordinate column 403, a category column 404, a feature column 405, a security level column 406, and a file name column 407.

The ID column 401 stores a character that serves as the identifier of a component image. The component image can be identified in the input image according to the identifier.

The upper left coordinate column 402 and the lower right coordinate column 403 store the positions of the component images in the input image. For example, in a case where the component image is rectangular, a plane space is set so that the longitudinal side of the image is employed as an X-axis, and that the lateral side thereof is employed as a Y-axis. The coordinate of the upper left corner of the component image in the input image is stored in the upper left coordinate column 402. The coordinate of the lower right corner of the component image in the input image is stored in the lower right coordinate column 403. Thus, the position of the component image in the input image can be specified.

The category column 404 stores data representing the category (the character area, the graphic area, the table area, or the photographic area) of the component image. For example, the area Area1 (311) is a character area (including Japanese texts). The area Area2 (312) is a graphic area. The area Area3 (313) is a photographic area. The area Area4 (314) is a character area (including English texts).

The feature column 405 stores data representing a result of the feature extraction performed by the image decomposition module 112. When the similarity is calculated by the similarity calculation module 122, a feature extraction is performed. However, in a case where this feature extraction is the same processing performed by the image decomposition module 112, the necessity for performing the same extraction processing twice is eliminated.

The security level column 406 stores the security levels set by the security level setting module 113. A result of setting the security levels 330 shown in FIG. 3 is an example of setting the security level to each of the component images. A message shown on row 331 indicates that “the security level set to the area Area1 (311) is low”. A message shown on row 332 indicates that “the security level set to the area Area2 (312) is middle”. A message shown on a row 333 indicates that “the security level set to the area Area3 (313) is high”. A message shown on row 3332 indicates that “the security level set to the area Area4 (314) is highest”.

The security level setting module 113 determines according to the security level of the component image whether the component image is stored in the image storage module 114. That is, the component image, whose security level is low, is not stored in the image storage module 114. Other component images are stored in the image storage module 114. In the example of the result of setting the security levels shown in FIG. 3, data represented by the area Area1 (311) is not stored therein. Data represented by the areas Area2 (312), Area3 (313), and Area4 (314) are stored therein.

The file name column 407 stores data presenting the file names of the component images. The file names enable accesses to the component images.

The component image included in an image 32 shown in FIG. 3 is the component image 340 input by the component image input module 121. That is, component images respectively represented by the areas Area1′ (321), Area2′ (322), Area3′ (323), and Area4′ (324) are input by the component image input module 121. Incidentally, an image represented by the area Area0′ (320) is a background image that is not a component image to be processed.

The image 32 is an electronic document including these component images. However, the image 32 can be a result of processing performed by each of the image input module 111 and the image decomposition module 112.

Similarity calculation 350 is performed by the similarity calculation module 122. Also, an image 36 represents a result output by the image output module 125. The image output module 125 is controlled by the output control module 124.

That is, in the case of the example shown in FIG. 3, as a result of the similarity calculation 350 performed by the similarity calculation module 122, results of the following determination of the similarity are obtained.

That is, the image represented by the area Area1′ (321) is not similar to any of the images represented by the areas Area2 (312) to Area4 (314).

The image represented by the area Area2′ (322) is similar to any of the images represented by the area Area4 (314) at a middle degree of similarity.

The image represented by the area Area3′ (323) is similar to any of the images represented by the area Area3 (313) at a high degree of similarity.

The image represented by the area Area4′ (324) is not similar to any of the images represented by the areas Area2 (312) to Area4 (314).

The image represented by the area Area1 (311) has a low security level and is not stored in the image storage module 14. Thus, the image represented by the area Area1 (311) is not an object image whose similarity is obtained.

The relation between the security level and the output mode is described below by referring to FIG. 5.

A security level table 500 is configured so that a security level column 501 and an output mode column 502 are paired. This table indicates that, for example, the component image, whose security level is “highest”, corresponds to an output mode in which “output is inhibited”, that the component image, whose security level is “high”, corresponds to an output mode in which this image is “output by being replaced with another image”, that the component image, whose security level is “middle”, corresponds to an output mode in which this image is “output by adding a watermark thereto and reducing the resolution to a low resolution”, and that the component image, whose security level is “low”, corresponds to an output mode in which this image is output by adding “watermark” thereto.

Incidentally, the expression “reducing the resolution to a low resolution” means that, for example, in a case where the component image is represented by the photographic area, the component image is changed to another image on which what is called mosaic processing is performed.

The watermark is an image that is difficult to view. However, information can be obtained by analyzing the image of the watermark through the use of a certain scanner. For example, the watermark is formed by embedding the time and date of printing, a printing operator, the number of a printing machine therein to track the source of the document.

The security level table 500 is referred to by the output control module 124.

In the case of the example of the image 32 shown in FIG. 3, no component images stored in the image storage module 114 are similar to the image represented by the area Area1′ (321). Thus, the image represented by the area Area1′ (321) is output without being changed (see an area Area1″ (361) in the image 36).

The degree of the similarity between the image represented by the area Area2′ (322) and the image represented by the area Area4 (314) is “middle”. Also, the security level of the area Area4 (314) is “highest”. Thus, the image represented by the area Area2′ (322) is not output. Although the area Area2″ (362) in the image 36 is enclosed with dashed lines, the presence of the area Area2″ at this position can be concealed without displaying the dashed lines.

The degree of the similarity between the image represented by the area Area3′ (323) and the image represented by the area Area3 (313) is “high”. The security level of the area Area3 (313) is “high”. Thus, the image represented by the area Area3′ (323) is replaced with another image that is equal in size to the original component image and that is filled in black (see the area Area3″ (363) in the image 36).

No component images stored in the image storage module 114 are similar to the image represented by the area Area4′ (324). Thus, the image represented by the area Area4′ (324) is output without being changed (see an area Area1″ (364) in the image 36).

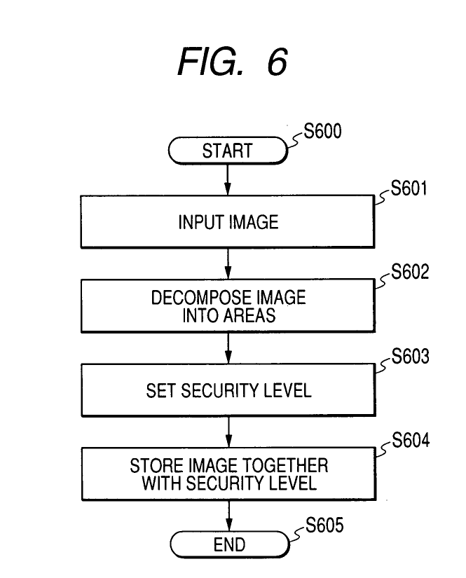

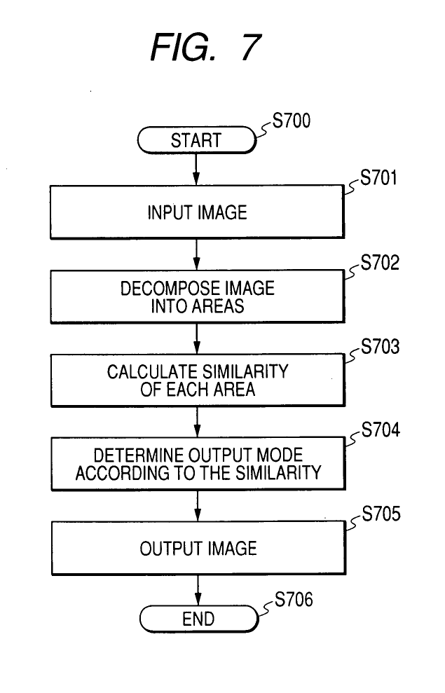

Next, operations (actions) of the present embodiment are described below by referring to FIGS. 6 and 7.

FIG. 6 is a flowchart illustrating an example of a process of storing an image, the security level of which is set.

In step S601, an image is input by the image input module 111.

In step S602, the image input in step S601 is decomposed by the image decomposition module 1112 into decomposition images.

In step S603, the security level setting module 113 sets security levels to the component images into which the input image is decomposed in step S602, respectively.

In step S604, the image storage module 114 stores the component images, into which the input image is decomposed in step S602, by associating the component images with the security levels set in step S603, respectively.

FIG. 7 is a flowchart illustrating the process of changing the output mode.

In step S701, an image is input by a scanner or the like.

In step S702, the image input in step S701 is decomposed into component images.

In step S703, the similarity calculation module 122 calculates the similarity between the component images, into which the input image is decomposed in step S702, and the component images stored in the image storage module 114.

In step S794, the output control module 124 controls the output mode according to the similarity calculated in step S703.

In step S705, the image output module 125 outputs the component image in the output mode controlled in step S704.

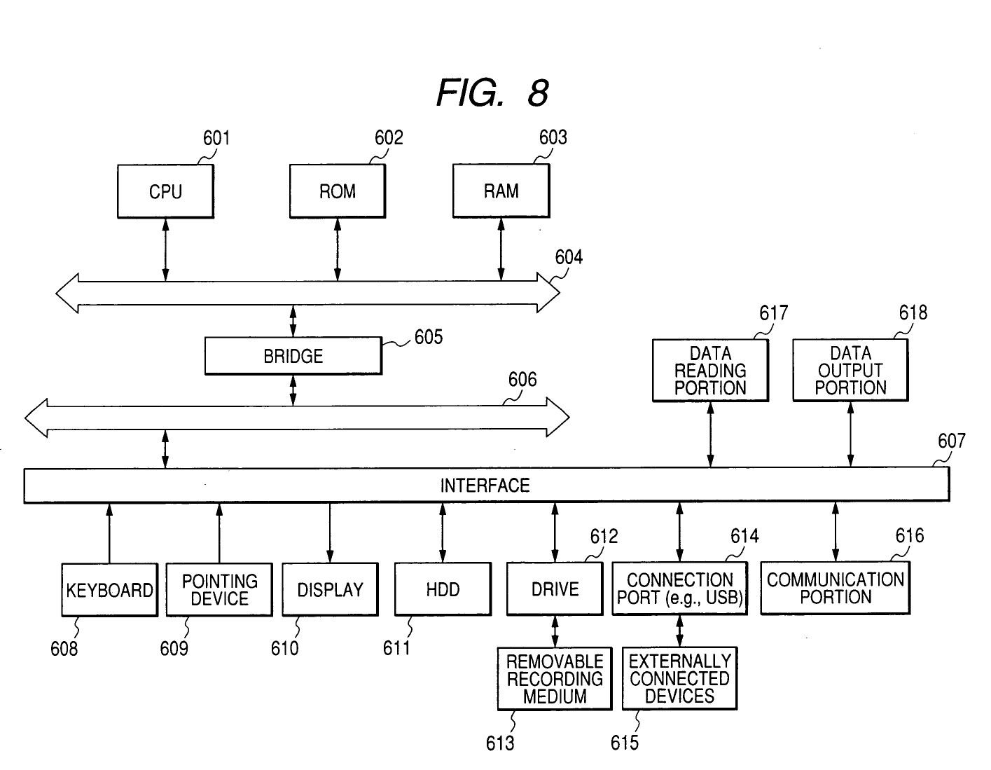

An example of the hardware configuration of an image processing system according to the present embodiment is described below by referring to FIG. 8. This figure illustrates the image processing system constituted by, for example, a personal computer (PC) and the like, to have a data reading portion 617, which includes a scanner, and a data output portion 618 including a printer.

A CPU (Central Processing Unit) 601 is a control unit that performs processing according to computer programs, in which execution sequences of the various modules, that is, the image decomposition module 112, the security level setting module 113, the similarity calculation module 122, and the output control module 124, having been described in the foregoing description of the embodiments are described.

A ROM (Read-Only Memory) 602 stores programs and operation parameters used by the CPU 601. A RAM (Random Access Memory) 603 stores programs executed by the CPU 601 and also stores parameters which are appropriately changed during the execution of the programs. The ROM 602 and the RAM 603 are connected to each other through a host bus 604 including a CPU bus.

The host bus 604 is connected to an external bus 606, such as a PCI (Peripheral Component Interconnect/Interface) bus, through a bridge 605.

A keyboard 608 and a pointing device 609, such as a mouse, are input devices operated by an operator. A display device 610 includes a liquid crystal display device or a CRT (Cathode Ray Tube) and displays various kinds of information as texts and images.

A HDD (Hard Disk Drive) 611 incorporates a hard disk and drives the hard disk. The HDD 611 records programs, which are executed by CPU 601, and information and also reproduces the information. The hard disk stores the images input by the image input module 111 and also stores the component images into which the input image is decomposed by the image decomposition module 112. The hard disk also stores various computer programs, such as various data processing programs.

A drive 612 reads data or programs data or programs recorded on a removable recording medium 613, such as a magnetic disk, an optical disk, a magneto-optical disk, or a semiconductor memory, mounted therein. The drive 612 supplies the read data or program to the RAM 603 connected thereto through an interface 607, the external bus 606, the bridge 605, and the host bus 604. The removable recording medium 613 can be utilized as a data recording area similar to the hard disk.

A connection port 614, to which externally connected devices are connected, have connection portions, such as a USB, and an IEEE1394. The connection port 614 is connected to the CPU 601 through the interface 607, the external bus 606, the bridge 605, and the host bus 604. A communication portion 616 is connected to the network, and performs data communication with external devices. The data reading portion 617 is, for example, a scanner, and performs image reading processing. The data output portion 618 is, for example, a printer, and performs image data output processing.

FIG. 8 illustrates only an example of the hardware configuration of the image processing system. The image processing system according to the present embodiment is not limited thereto. Any other configuration of the image processing system can be employed as long as the image processing system can implement the modules described in the foregoing description of the present embodiment. For example, a part of the modules may be constituted by specialized hardware (for example, an ASIC (Application Specific Integrated Circuit)). Alternatively, a part of the modules may be provided in an external system and also may be connected to the image processing system through a communication circuit. Alternatively, a plurality of systems, each of which is configured as shown in FIG. 8, may be connected to one another through communication circuits and may be coordinated with one another. Additionally, the image processing system according to the invention may be incorporated into a copying machine, a facsimile, a scanner, a printer, and a compound machine (referred to also as a multiple-function copier, which has the functions of a scanner, a printer, a copier, and a facsimile).

In the foregoing description of the above embodiment, it has been described that the output mode is controlled according to the security level, and that whether the component image is output depends upon the security level. However, the output mode may be controlled according to the ID input by the ID input module 123. For example, in a case where the ID input by the ID input module 123 identifies a person, whose security level is high, the output mode can be controlled so that the security levels of the component images were lowered by one level. That is, the output mode can be controlled so that even the component image having a high degree of security level can be presented to a person whose security level is high. Conversely, in a case where the ID input by the ID input module 123 identifies a person, whose security level is low, the output mode can be controlled so that the security levels of the component images were raised by one level. That is, the output mode can be controlled so that even the component image having a low degree of security level is inhibited from being presented to a person whose security level is low.

Also, the application of the output mode may be changed according to the security level. For example, in a case where there are two component images stored in the storage module corresponding to the same input component image, where one of the two component images has a relatively low degree of similarity to the same input component image and also has a relatively high security level, and where the other component image has a relatively high degree of similarity to the same input component image and also has a relatively low security level, it can be determined that the output mode corresponding to the high security level of the image is employed.

Although a still image is an object to be processed in the above embodiment, a moving picture can be employed as an object to be processed. That is, moving pictures can be handled by performing the above processing on an image of each frame of the moving picture. In a case where there is a little change between frame images at that time, a processing time can be shorten by diverting a result of the processed frame image.

The program described in the foregoing description of the embodiment can be stored in a recording medium. Also, the program described in the foregoing description of the embodiment can be provided by communication means. In this case, for example, the program according to the present invention, which has been described in the foregoing description of the embodiment, can be treated as the invention relating to a “computer-readable recording medium on which the program is recorded”.

The “computer-readable recording medium on which the program is recorded” is a recording medium which is used for installation, execution, and distribution of a program and which is adapted so that a program is recorded thereon, and that a computer can read the recording medium.

Incidentally, the recording medium includes, for example, digital versatile disks (DVD) according to standards “DVD-R, DVD-RW, DVD-RAM” established by the DVD Forum, and to standards “DVD+R, and DVD+RW” established by the DVD+RW alliances. The recording medium also includes compact disks (CD), for example, a compact disk read-only memory (CD-ROM), a compact-disk recordable (CD-R), and a compact-disk rewritable (CD-RW). The recording media also includes an magneto-optical disk (MO), a flexible disk (FD), magnetic tape, a hard disk, a read-only memory (ROM), an electrically erasable programmable read-only memory (EEPROM), a flash memory, and a random access memory (RAM).

Additionally, the program or a part thereof can be archived or distributed by being recorded on the recording medium. Also, the program or a part thereof can be transmitted by communication using transmission media, for example, wired networks such as a Local Area Network (LAN), a Metropolitan Area Network (MAN), a Wide Area Network (WAN), the Internet, an intranet, an extranet, wireless communication networks, or the combination thereamong. Alternatively, the program or a part thereof can be carried by using carrier waves.

The above program may be a part of another program, and may be recorded on a recording medium together with another program.

What is claimed is:

1. An image processing apparatus comprising:
an image decomposition unit that decomposes an input image into component images constituting the input image;
a confidentiality setting unit that sets a confidentiality being a degree of security of each of the component images into which the input image is decomposed by the image decomposition unit; and
a storage unit that stores each of the component images by associating the confidentiality therewith, the confidentiality being set by the confidentiality setting unit.

2. The image processing apparatus as claimed in claim 1, further comprising:
a similarity calculation unit that calculates a similarity being a degree at which an input component image is similar to the component image stored in the storage unit; and
an output controller that controls an output mode, in which the input component image is output, according to the similarity calculated by the similarity calculation unit, and to the confidentiality of each of the component images stored in the storage unit.

3. The image processing apparatus as claimed in claim 2, further comprising:
an image input unit that inputs the input image;
an identifier input unit that inputs an identifier of an operator; and
an image output unit that outputs the input image including the component image according to the output mode controlled by the output controller,
wherein
the output controller controls an output mode, in which the input component image is output, according to the identifier of the operator input by the identifier input unit, to the similarity calculated by the similarity calculation unit, and to the confidentiality of each of the component images stored in the storage unit.

4. An image processing apparatus comprising:
a storage unit that stores component images, into which an image is decomposed, by associating each of the component images with a corresponding one of confidentialities, which are respectively set at the component images;
a similarity calculation unit that calculates a similarity being a degree at which a component image input thereto is similar to the component image stored in the storage unit; and
an output controller that controls an output mode, in which the input component image is output, according to the similarity, which is calculated by the similarity calculation unit, and to the confidentiality of the component image stored by the storage unit.

5. An image processing method comprising:
decomposing an input image into component images constituting the input image;
setting a confidentiality being a degree of security of each of the component images into which the input image is decomposed; and
storing the component images by associating each of the component images with the confidentiality set in the setting of the confidentiality.

6. A computer readable medium storing a program causing a computer to execute a process for processing an image, the process comprising:
decomposing an input image into component images constituting the input image;
setting a confidentiality being a degree of security of each of the component images into which the input image is decomposed; and
storing the component images by associating each of the component images with the confidentiality set in the setting of the confidentiality.

7. A computer data signal embodied in a carrier wave for enabling a computer to perform a process for processing an image, the process comprising:
decomposing an input image into component images constituting the input image;
setting a confidentiality being a degree of security of each of the component images into which the input image is decomposed; and
storing the component images by associating each of the component images with the confidentiality set in the setting of the confidentiality.

8. A computer readable medium storing a program causing a computer to execute a process for processing an image, the process comprising:
decomposing an input image into component images constituting the input image;
setting a confidentiality being a degree of security of each of the component images into which the input image is decomposed; and
storing the component images by associating each of the component images with the confidentiality set in the setting of the confidentiality.

9. A computer readable medium storing a program causing a computer to execute a process for processing an image, the process comprising:
storing component images, into which an image is decomposed, by associating each of the component images with a corresponding one of confidentialities, which are respectively set at the component images;
calculating a similarity being a degree at which an input one of the component images is similar to the component image stored by said storage control function; and
controlling an output mode, in which the input component image is output, according to the similarity calculated in the calculating of the similarity, and to the confidentiality of the component image stored.

10. A computer data signal embodied in a carrier wave for enabling a computer to perform a process for processing an image, the process comprising:
storing component images, into which an image is decomposed, by associating each of the component images with a corresponding one of confidentialities, which are respectively set at the component images;
calculating a similarity being a degree at which an input one of the component images is similar to the component image stored by said storage control function; and
controlling an output mode, in which the input component image is output, according to the similarity calculated in the calculating of the similarity, and to the confidentiality of the component image stored.
